(19) United States
(12) Patent Application Publication
(10) Pub. No.: US 2005/0216466 A1
(43) Pub. Date: Sep. 29, 2005

(54) Method and system for acquiring resource usage log and computer product

(75) Inventors: Yuji Miyamoto, Tokyo (JP); Yusuke Yamanaka, Tokyo (JP); Yue Tian, Tokyo (JP); Takaoki Sasaki, Tokyo (JP); Mikito Hikita, Tokyo (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/895,341

(22) Filed: Jul. 21, 2004

(30) Foreign Application Priority Data
Mar. 29, 2004 (JP) 2004-097069

(51) Int. Cl. G06F 17/30

(52) U.S. Cl. 707/9

(57) ABSTRACT

Based on user permission information read from a write-protected portable medium, it is determined whether an application is permitted to use a resource. If the application is permitted to use the resource, the write protection of the portable medium is released, usage log information is written into the medium.

### BACKGROUND OF THE INVENTION

1) Field of the Invention

The present invention relates to a resource usage log acquisition system and computer product that create and update a usage log when usage of a computer resource is temporarily permitted, in a configuration such that usage of computer resources is normally prohibited.

2) Description of the Related Art

It is usual to prohibit usage of computer resources to prevent leakage of information. However, there some systems temporarily permit usage of computer resources but create logs of the usage.

FIG. 8 illustrates a configuration of a local terminal 150 having a conventional resource usage log management function. The local terminal 150 includes an operating system (OS) 51, an application 52, a printer 53, a drive 54, a socket communication 55, a Windows(R) network 56, a resource usage limiting unit 41, and a log manager 42. The printer 53, the drive 54, the socket communication 55, and the Windows(R) network 56 are “resources”. The resource usage limiting unit 41 limits usage of one or more of the resources 53 to 56, based on the application 52. If the resource usage limiting unit 41 permits the usage of the resources by the application 52 and the application 52 uses the resources, the log manager 42 creates a usage log file or updates an existing usage file and records usage of the resources used by the application 52.

In Japanese Patent Application Laid-open No. H11-143840, a server monitors a state of a client based on a configuration of a client server, and prohibits the client's usage of resources. The usage of the resources is temporarily permitted in response to an application for usage submitted by the client, and a usage log is recorded in the server.

In Japanese Patent Application Laid-open No. 2001-14188, accounts that enable use of resources are prepared in a terminal. When an account makes a request to use a resource, the account is temporarily allowed to use the resource, and a usage log is acquired. The usage log is transmitted to the server on a real time basis, or is stored in the client terminal and transmitted to the server at a predetermined timing.

However, the conventional methods require a network environment, where a terminal can be connected to a server, to collect and to centrally manage logs. Further, if the network cannot be used temporarily, logs are stored locally, and the logs are transmitted to the server at a predetermined timing. In such cases, the logs stored in the local terminal might be tampered. To acquire a log when a resource is used in a local terminal with which a network cannot be connected, an administrator needs to visit a location of the local terminal, and actuate the local terminal to acquire the log.

### SUMMARY OF THE INVENTION

It is an object of the invention to at least solve the problems in the conventional technology.

A resource usage log acquisition program according to an aspect of the present invention contains instructions which when executed on a computer cause the computer to execute determining whether an application is permitted to use a resource, by reading usage permission information that is stored in a protected area of a portable medium with write protection enabled, to obtain a determination result, wherein the usage permission information is information about permitting an application to use a resource; and log acquiring/writing including acquiring usage log information based on the determination result, releasing the write protection of the portable medium, and writing the usage log information acquired into the protected area, wherein the usage log information is information about usage of the resource by the application.

A resource usage log acquisition system according to another aspect of the present invention includes a portable medium that stores user permission information and usage log information, in a protected area with write protection enabled, wherein the user permission information is information about permitting an application to use a resource, and the usage log information is information about usage of the resource by the application; and a local terminal that includes
1) a resource usage permission/prohibition determining unit that determines whether an application is permitted to use the resource based on the user permission information, by reading the user permission information stored, to thereby obtain a determination result; and
2) a log writing unit that acquires the usage log information based on the determination result, releases the write protection of the portable medium, and writes the usage log information acquired, into the protected area.

A resource usage log acquisition system according to still another aspect of the present invention includes a portable medium that stores user permission information and usage log information, in a protected area with write protection enabled, wherein the user permission information is information about permitting an application to use a resource, and the usage log information is information about usage of the resource by the application; a management server including a usage permission information writing unit that writes the usage permission information in the protected area of the portable medium by releasing the write protection of the portable medium; and a local terminal that includes
1) a resource usage permission/prohibition determining unit that determines whether an application is permitted to use the resource based on the user permission information, by reading the user permission information stored, to thereby obtain a determination result; and
2) a log writing unit that acquires the usage log information based on the determination result, releases the write protection of the portable medium, and writes the usage log information acquired, into the protected area.

A resource usage log acquisition method according to still another aspect of the present invention includes determining whether an application is permitted to use a resource, by reading usage permission information that is stored in a protected area of a portable medium with write protection enabled, to obtain a determination result, wherein the usage permission information is information about permitting an application to use a resource; and log acquiring/writing including acquiring usage log information based on the determination result, releasing the write protection of the portable medium, and writing the usage log information acquired into the protected area, wherein the usage log information is information about usage of the resource by the application.

A computer-readable recording program according to still another aspect of the present invention stores the usage log acquisition program according to above aspect.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 illustrates a configuration of a resource usage log acquisition system;

FIG. 2 is a functional block diagram of a resource usage limiting unit that is a main unit of a resource usage log acquiring device;

FIG. 3 is an explanatory diagram of a step in which the resource usage limiting unit reads usage permission information stored in a token, and permits or prohibits the usage of resources;

FIG. 4 is one example of the usage permission information described in a usage permission information file stored in the token;

FIG. 5 is a flowchart of acquiring resource usage log performed by the resource usage log acquiring device;

FIG. 6 illustrates a resource usage log acquisition system according to a first embodiment;

FIG. 7 illustrates an example configuration of hardware in the resource usage log acquiring device; and

FIG. 8 illustrates a configuration of a local terminal having a conventional resource usage log management function.

### DETAILED DESCRIPTION

Exemplary embodiments of a method and a system for acquiring resource usage log acquisition and a computer product according to the present invention are explained below with reference to the accompanying drawings.

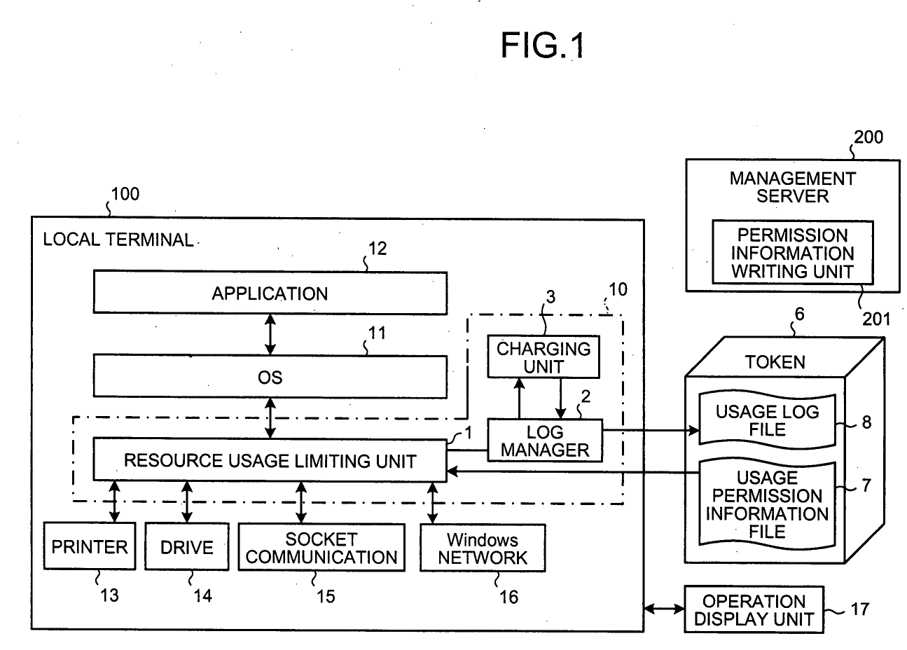

FIG. 1 illustrates a configuration of a resource usage log acquisition system according to an embodiment of the present invention. The resource usage log acquisition system includes a management server 200, a token 6, and a local terminal 100.

The token 6 includes a protected area, which with write protection enabled. The token 6 stores a usage permission information file 7 and a usage log file 8 in the protected area.

The management server 200 includes a permission information writing unit 201. The permission information writing unit 201 releases the write protection in the protected area of the token 6, and writes usage permission information that is information about enabling an application 12 of the local terminal to use resources. Thus, the usage permission information file 7 is created or updated.

The local terminal 100 includes a resource usage log acquiring device 10. The local terminal 100 includes an OS 11, the application 12, and a printer 13, a drive 14, a socket communication 15, and a Windows® network 16 as resources. The local terminal 100 further has an operation display unit 17.

The resource usage log acquiring device 10 includes a resource usage limiting unit 1, and a log manager 2. Further, the resource usage log acquiring device 10 can have a charging unit 3.

The operation display unit 17 accepts input from a user who operates the local terminal 100.

In the local terminal 100, the resource usage log acquiring device 10 according to the embodiment of the present invention normally prohibits or limits the usage of the resources including the printer 13, the drive 14, the socket communication 15, and the Windows® network 16. For example, the resource usage log acquiring device 10 makes a setting that prohibits the local terminal 100 from outputting a file opened by the application 12 via the printer 13.

As an example, the application 12 is a general-purpose application such as Microsoft® Word®, and is run on the OS 11.

The OS 11 is software for general management so that computer hardware and software such as Windows® and UNIX® can be used effectively.

The resource usage limiting unit 1 can read and open a file in the local terminal 100 after Word® is run, but cannot print the opened file using the printer 13.

When the user of the local terminal 100 uses the resources in the local terminal 100 to print out contents of the opened file, the token 6 is connected to the local terminal 100. The resource usage log acquiring device 10 reads the permission information, and permits or prohibits the usage of the resources based on the permission information read. This is the concept of the present invention. The usage permission information is written by a permission information writing unit 201 of the management server 200.

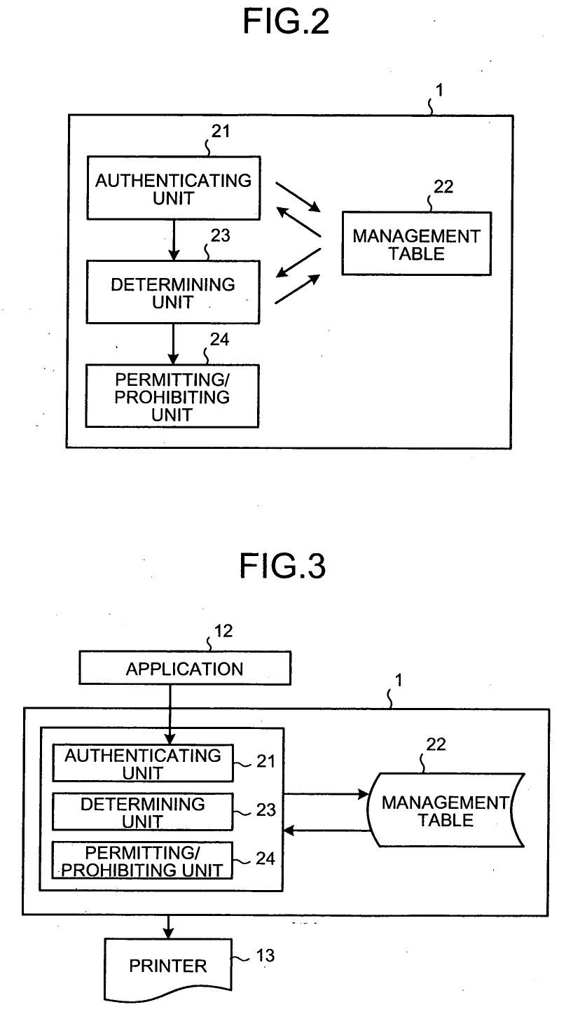

FIG. 2 is a functional block diagram of the resource usage limiting unit that is a main unit of the resource usage log acquiring device. FIG. 3 is an explanatory diagram of a step in which the resource usage limiting unit reads the usage permission information stored in the token, and permits or prohibits the usage of the resources.

The resource usage limiting unit 1 in the resource usage log acquiring device 10 includes an authenticating unit 21, a management table 22, a determining unit 23, and a permitting/prohibiting unit 24. The authenticating unit 21 reads the user permission information file 7 when connected to the token 6. The authenticating unit 21 collates user identification information written into the usage permission information file 7 with management information in the management table 22 to determine whether the user is legitimate.

If the authenticating unit 21 determines that the user is legitimate, the determining unit 23 reads the usage permission information relating to the resources in the usage permission information file 7 stored in the token 6. The determining unit 23 collates the usage permission information with the management table 22 to determine whether the application 12 can use the resources. The permitting/prohibiting unit 24 permits the application 12 to use the resources based on what the determining unit 23 determines.

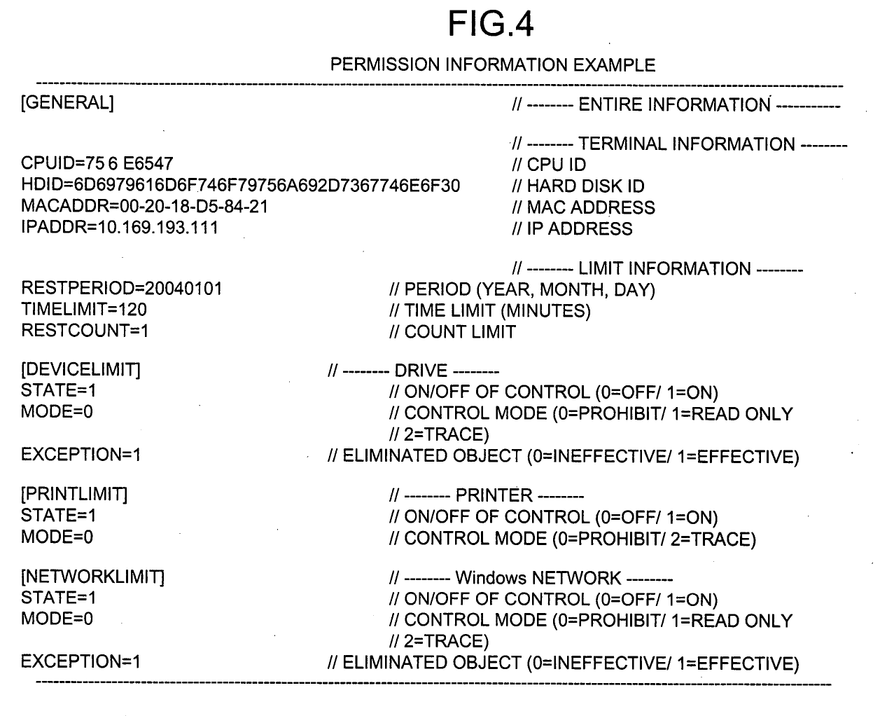

FIG. 4 is one example of the usage permission information described in the usage permission information file stored in the token. The usage permission information includes CPU ID, a hard disk ID, MAC address, and IP address as terminal information.

The usage permission information includes information about period limit, time limit, and count limit as limit information for limiting the usage of resources. The usage permission information further includes information about ON/OFF control of a usable drive, a control mode, and eliminated object information. Further, the usage permission information includes information about ON/OFF control of the printer and information about the control mode. The usage permission information includes information about ON/OFF control of the Windows® network, the control mode, and eliminated object information.

The log manager 2 acquires resource usage information relating to usage of the used resources, the usage of which is permitted by the permitting/prohibiting unit 24, and creates or updates the usage log file 8 in the token 6. The log manager 2 writes the usage log information, indicating usage of resources, into the usage log file 8 in the protected area by releasing write protection of the protected area.

The charging unit 3 calculates a price charged for the usage of the resources based on the usage information acquired by the log manager 2. The charging unit 3 writes the charge calculated into the usage log file 8.

The charging unit may be included in the management server 200 instead of being included in the resource usage log acquiring device 10. The charging unit 3 reads the usage log file 8 from the token 6 to calculate the charge.

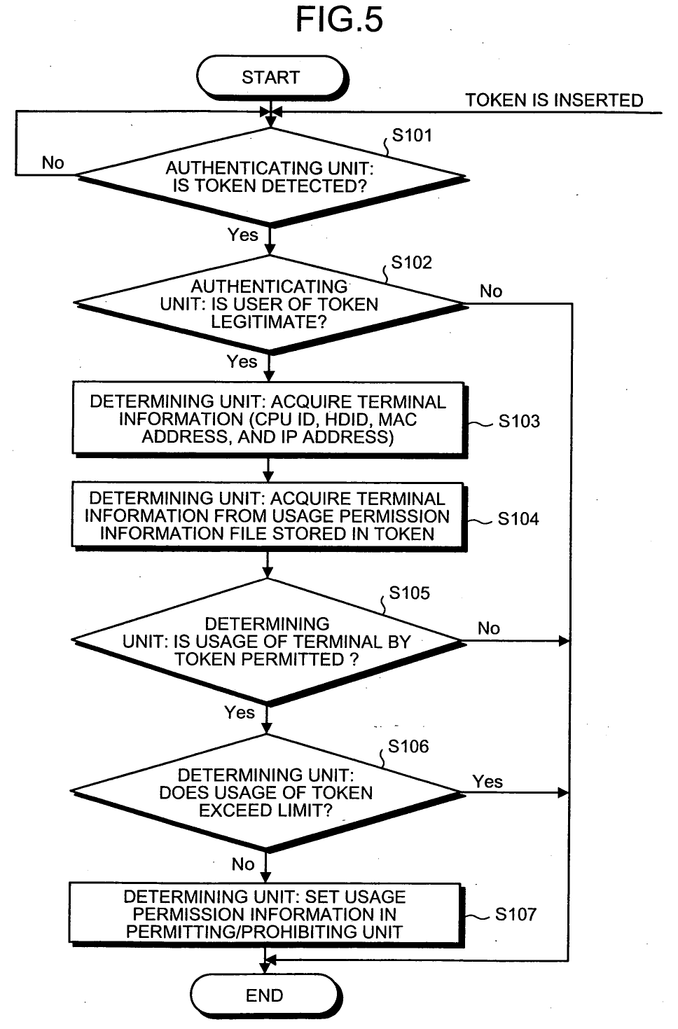

FIG. 5 is a flowchart of acquiring the resource usage log performed by the resource usage log acquiring device. Initially, the local terminal 100 is set so that the usage of the resources is prohibited. The user connects the token 6 to the local terminal 100. The authenticating unit 21 in the resource usage limiting unit 1, waits for the token (step S101). If the authenticating unit 21 detects the token 6 (Yes at step S101), the authenticating unit 21 reads user identification information from the usage permission information file 7 stored in the token 6. The authenticating unit 21 collates the user identification information with the management table 22, to authenticate the user (step S102). Here, the authenticating unit 21 reads the user identification information from the token 6 for collating. Alternatively, the user may insert the token 6, and input the user identification information via the operation display unit 17. The authenticating unit 21 may receive the user identification information input, and determine whether the user is legitimate.

If the authenticating unit 21 determines that the user of the token 6 is not legitimate (No at step S102), the process ends. If the authenticating unit 21 determines that the user is legitimate (Yes at step S102), the determining unit 23 acquires terminal information including at least one of CPU ID, hard disk drive (HDD) ID, MAC address, and IP address of the local terminal 100, and creates or updates the management table 22 (step S103). If the management table 22 has been already updated, further updating is not required, and the management table 22 is used in the following steps.

The determining unit 23 acquires terminal information, relating to the usage permission information, from the usage permission information file 7 in the token 6 (step S104), and collates the terminal information with the management table 22. The determining unit 23 determines whether usage of the terminal by the token 6 is permitted (step S105). If the determining unit 23 determines that the usage by the token 6 is not permitted (No at step S105), the process ends.

If the determining unit 23 determines that the usage of the terminal by the token 6 is permitted (Yes at step S105), the determining unit 23 further determines whether the usage exceeds the limit, based on the usage permission information stored in the token 6 (step S106). If the determining unit 23 determines that the usage exceeds the limit (Yes at step S106), the process ends.

If the determining unit 23 determines that the usage of the token 6 does not exceed the limit (No at step S106), the determining unit 23 sets the usage permission information contained in the usage permission information file 7 into the permitting/prohibiting unit 24 (step S107).

The permitting/prohibiting unit 24 permits the application 12 to use the resources based on the usage permission information set.

The usage information of the resource that is used by the application 12 based on permission from the permission/prohibition 24 is transmitted to the log manager 2. The log manager 2 releases the write protection of the protected area in the token 6, and creates or updates the usage log file 8 into which the usage log information is written.

In the local terminal 100, the resource usage information stored in the token 6 is read, usage permission is determined, the resource usage information is set in the resource usage limiting unit 1, and the usage of the resources is permitted. Records about the use of the permitted resources by the application 12 are stored in the usage log file 8 in the protected area of the token 6. Therefore, the information about usage of resources by the local terminal 100 remain intact, and the information is acquired by the management server 200 from the token 6, without connecting to a network. Thus, the resource usage log records of the local terminal 100 can be safely acquired.

That is, even a terminal that is not connected to a network or a terminal that cannot be connected to a network due to any reason, can securely collect and centrally manage the resource usage logs at the time when resources that are normally prohibited from being used are temporarily used.

Further, any tampering of the resource usage logs by users is prevented until an administrator collects the logs.

Limitations of usage count of resources or of terminals to be used can be set in the user permission information. Therefore, the unlimited usage of the resources by an unauthorized user or loss of the token 6 is prevented.

The usage terminal has limits, and plural pieces of the usage permission information for a plurality of usage terminals are stored in one token. Therefore, the usage terminals can be used in an automatic switching manner.

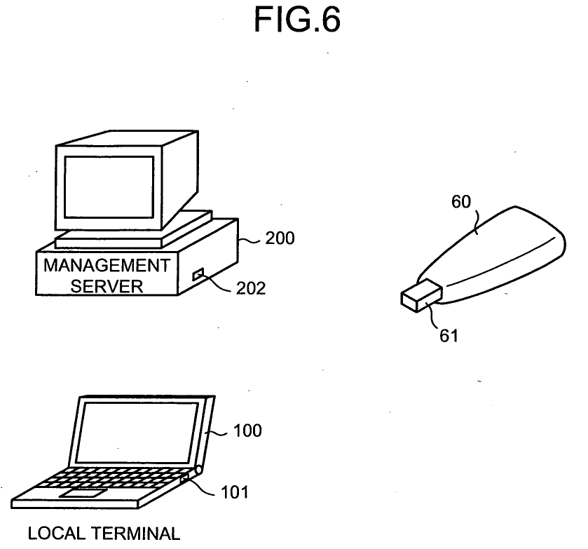

FIG. 6 illustrates the resource usage log acquisition system according to a first embodiment. The local terminal 100 is a terminal for outside use, such as a laptop computer used for insurance sales calls. The local terminal 100 stores classified information such as client information. Sufficient data can be used in the local terminal 100, and the resource usage log acquiring device 10 incorporated into the local terminal 100 prohibits the data from being output to the outside. However, it is also assumed that the local terminal may be used outside of an office and may be used without being connected to a network, and that data are output if needed, with a notification to an administrator.

When the user outputs data in the local terminal 100 to the outside, the user requests an administrator for permission. The administrator inserts an exclusive universal serial bus (USB) key 60 into a USB port 202 of the management server 200 in response to the request. The administrator writes the usage permission information file 7 in a write protected area of the USB key 60 via an operation input unit (not shown) of the management server 200. That is to say, a permission information writing unit 201 which accepts an input signal from the operation input unit releases the write protection of the protected area in the USB key 60, and accepts an operation input from the administrator. The permission information writing unit 201 rewrites or creates the usage permission information relating to permission/prohibition of the resources in the usage permission information file 7 stored in the protected area of the token 6.

The usage permission information to be written by the permission information writing unit 201 is set as, for example, “External device acquires a log”, “Printer acquires a log”, and “Network acquired a log”. The USB key 60 is removed from the USB port 202 and lent to a user. Alternatively, some USB keys are prepared in advance, and are lent to the user in response to the user's requests.

If a count for the usage of the resources should be limited besides the permission/prohibition of the resources, information about usable period, usable time, and usable count is set as the usage permission information and stored in the USB key 60. If the usage permission information limits the local terminal to be used, CPU ID, hard disk ID, MAC address, and IP address of the usable terminal are also set. In the case of setting the IP address, if a part of the IP address is set, a range of IP addresses within a network segment can be rendered usable.

The user who operates the local terminal 100 normally inserts the USB key 60 lent by the administrator into the USB port 101 of the local terminal 100 that is normally prohibited from outputting data. When the USB key 60 is inserted into the USB port 101, the authenticating unit 21 in the resource usage limiting unit 1 of the resource usage log acquiring device 10 in the local terminal 100 authenticates the USB key 60. When the authenticating unit 21 determines that the USB key 60 is legitimate, the determining unit 23 reads the usage permission information stored in the USB key 60.

If the usage permission information read includes limits of usage count or the like and limit information of the usage terminal, the determining unit 23 of the resource usage limiting unit 1 determines whether the usage period and a usage count are within the limits and if the usage terminal is permitted to use resources.

If the determining unit 23 determines the usage count and the usage time as legitimate and determines the terminal usable, it sets permission/prohibition of the usage of the resources in the permitting/prohibiting unit 24 based on the usage permission information.

If the determining unit 23 applies the permission/prohibition of the usage of the resources to the permitting/prohibiting unit 24, the usage limit of the resources in the local terminal 100 is canceled according to the setting of the applied usage permission. Therefore, the user can use the permitted resources. For example, if using the printer 13 is permitted, data can be printed. At this time, the resource usage log acquiring device 10 is set to acquire a log based on the resource usage permission information, the device 10 acquires information relating to the data brought out by the user as the log. The resource usage log acquiring device 10 releases the write protection of the protected area in the USB key 60 to write the log into the usage log file 8.

After the user outputs the necessary data to the outside to the printer or the like, the user returns the USB key 60 to the administrator. The administrator inserts the socket 61 of the USB key 60 into the USB port 202 of the management server 200, and reads the usage log file 8 of the USB key 60 to check the data output.

Further, the administrator removes the usage log file 8 from the USB key 60, and stores the usage log file 8 in the management server 200. If a problem such as information leakage occurs, the administrator can identify the source of the leaked information from the log information.

If a charging unit that calculates the charge (not shown) is included in the management server 200, the charge is calculated based on the resource usage record in the usage log file 8.

Another operational example of the local terminal 100 having the resource log acquiring device 10 according to a second embodiment is browsing of personal information in an electronic library or other public institutions. A user of the local terminal receives a USB key from an administrator, inserts the USB key into the local terminal, and returns it to the administrator. This technical process is similar to that in the first embodiment. The function of the calculating the charge may be provided either in the local terminal 100 or in the management server 200 that receives the USB key 60 and reads the log.

The user can browse data in the local terminal 100 via the local terminal 100 free of charge. However, for outputting the data, the user must borrow the USB key from the administrator. At the time of lending the USB key, the administrator sets a data output count and a data output period, based on which the charge can be calculated.

Alternatively, no limit is set before lending the USB key, and the usage of the resource may be charged based on the resource usage log information read after the USB key is returned.

When the data in the local terminal having the resource usage log acquiring device are output, the resource usage log is safely acquired. The charge can be calculated accurately based on the resource usage record. Thus, with the simple system and the simple operation, browsing is free of charge, whereas outputs such as printouts are charged.

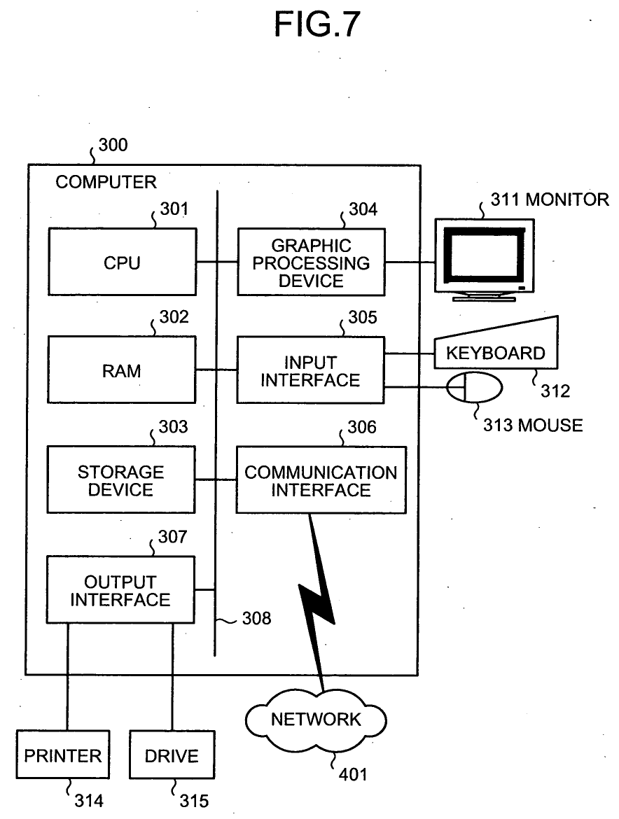

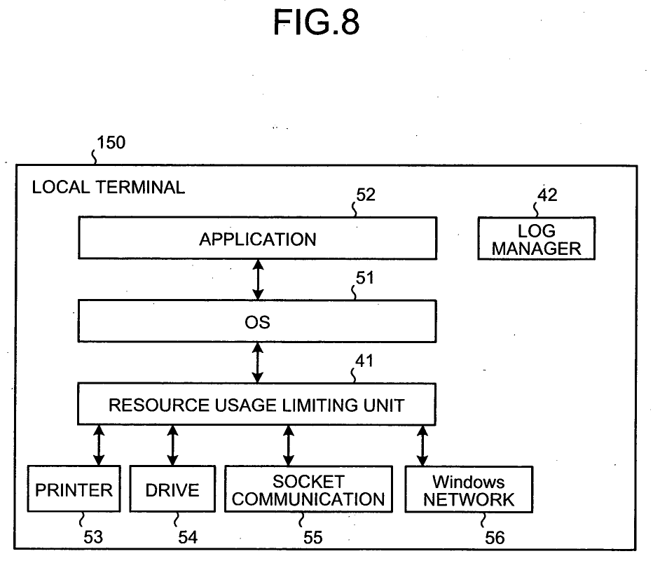

FIG. 7 illustrates an example configuration of the hardware in the resource usage log acquiring device. The resource usage log acquiring device explained above can be realized by executing a computer program in a computer system such as a personal computer or a work station. A computer 300 is entirely controlled by a CPU 301. A bus 308 connects the CPU 301 to a random access memory (RAM) 302, a storage device 303, a graphic processing device 304, an input interface 305, a communication interface 306, and an output interface 307. The RAM 302 temporarily stores at least a part of an OS program, an application program to be executed by the CPU 301, and various data required by the CPU 301. The storage device 303 may be an HDD, and stores OS, various driver programs, application programs, and the like.

The graphic processing device 304 is connected to a monitor 311. The graphic processing device 304 displays an image on a screen of the monitor 311, based on instructions from the CPU 301. The input interface 305 is connected to a keyboard 311 and a mouse 313. The input interface 305 transmits a signal sent by the keyboard 312 or the mouse 313 to the CPU 301 via the bus 308. The output interface 307 is connected to a printer 314 and a drive 315. The output interface 307 transmits the signal sent by the CPU 301 to the printer 314 and the drive 315, via the bus 308.

The communication interface 306 is connected to a network 401. The communication interface 306 transmits/receives data to/from other computers via the network 401.

The above hardware configuration can realize the processing function in the embodiment. In order to realize the embodiment on the computer 300, a driver program is installed on the computer 300.

The computer 300 reads and executes the resource usage log acquisition program recorded in a predetermined recording medium, to realize the resource usage log acquiring device. The predetermined recording medium includes “portable physical media” such as a flexible disk (FD), a CD-ROM, a magneto optical (MO) disk, a digital versatile disk (DVD), a magneto-optical disk, and an IC card. The recording medium further includes “communication media”, which store the program for a short time at the time of transmission of the program, such as an HDD provided within and outside the computer and a LAN/WAN connected to another computer system and a server via the network 401. Various recording mediums that record the resource usage log acquisition program readable by the computer 300 are adopted.

That is, the resource usage log acquisition program is recorded in the computer readable recording media such as “the portable physical media”, “fixed physical media”, and “the communication media”. The computer 300 reads and executes the resource usage log acquisition program, to realize the resource usage log acquiring device. The resource usage log acquisition program is executed not only by the computer 300 but also by another computer system or a server. Alternatively, the resource usage log acquisition program is executed by cooperation of the computers and the servers. The present invention can be also applied to these cases.

According to one aspect of the present invention, the resource usage log acquisition program, a terminal that is not connected to a network can use the resource based on the permission information, and the resource usage log can be preserved safely. Further, until the resource usage logs are collected, the resource usage logs are prevented from being tampered.

Moreover, the usage of the resources can be limited, and even if the portable medium is stolen and used illegally, unlimited usage can be prevented.

Furthermore, plural pieces of usage terminal permission information are stored in one token, so that the usage terminal permission information corresponding to each terminal can be used in an automatic switching manner.

Moreover, usage of the portable media or users can be limited.

Furthermore, charging information calculated based on the resource usage log information is stored in the protected area and therefore, the charging information is safe.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

1. A resource usage log acquisition program that contains instructions which when executed on a computer cause the computer to execute:
determining whether an application is permitted to use a resource, by reading usage permission information that is stored in a protected area of a portable medium with write protection enabled, to obtain a determination result, wherein the usage permission information is information about permitting an application to use a resource; and
log acquiring/writing including acquiring usage log information based on the determination result, releasing the write protection of the portable medium, and writing the usage log information acquired into the protected area, wherein the usage log information is information about usage of the resource by the application.

2. The resource usage log acquisition program according to claim 1, further causing the computer to execute:
permitting the application to use the resource, if the usage permission information read includes at least one of limit information that includes period limit information, time limit information, and count limit information for limiting usage of the resource and permitting the usage of the resource, and if the usage of the resource does not exceed the limit information.

3. The resource usage log acquisition program according to claim 1, wherein if the usage permission information read includes at least one of terminal information that includes an identification number of a hard disk in a usable terminal, an IP address, an identification number of a CPU, and a MAC address, then the determining is executed based on the terminal information.

4. The resource usage log acquisition program according to claim 1, wherein if the usage permission information read includes at least one of authentication information about the portable medium and authentication information about a user, the determining is executed based on the authentication information.

5. The resource usage log acquisition program according to claim 1, further causing the computer to execute:
acquiring charging information corresponding to the usage of the resource by the application, based on the usage log information acquired, releasing the write protection of the portable medium, and writing the acquired charging information acquired, into the protected area.

6. A resource usage log acquisition system, comprising:
a portable medium that stores user permission information and usage log information, in a protected area with write protection enabled, wherein the user permission information is information about permitting an application to use a resource, and the usage log information is information about usage of the resource by the application; and
a local terminal that includes
a resource usage permission/prohibition determining unit that determines whether an application is permitted to use the resource based on the user permission information, by reading the user permission information stored, to thereby obtain a determination result; and
a log writing unit that acquires the usage log information based on the determination result, releases the write protection of the portable medium, and writes the usage log information acquired, into the protected area.

7. The resource usage log acquisition system according to claim 6, further comprising:
a resource usage log acquisition permitting unit that permits the application to use the resource, if the usage permission information read includes at least one of limit information that includes period limit information, time limit information, and count limit information for limiting the usage of the resource and permitting the usage of the resource, and if the usage of the resource does not exceed the limit information.

8. The resource usage log acquisition system according to claim 6, wherein if the usage permission information read includes at least any of terminal information that includes an identification number of a hard disk in a usable terminal, an IP address, an identification number of a CPU, and a MAC address, then the resource usage permission/prohibition determining unit makes the determination based on the terminal information.

9. The resource usage log acquisition system according to claim 6, wherein if the usage permission information read includes at least one of authentication information about the portable medium and authentication information about a user, then the resource usage permission/prohibition determining unit makes the determination based on the authentication information.

10. The resource usage log acquisition system according to claim 6, further comprising:
a charging information acquiring unit that acquires charging information corresponding to the usage of the resource by the application, based on the usage log information acquired, releasing the write protection of the portable medium, and writing the charging information acquired, into the protected area.

11. The resource usage log acquiring system according to claim 6, wherein the portable medium is connected to the local terminal via a USB (Universal Serial Bus).

12. A usage log acquisition system, comprising:
a portable medium that stores user permission information and usage log information, in a protected area with write protection enabled, wherein the user permission information is information about permitting an application to use a resource, and the usage log information is information about usage of the resource by the application;
a management server including a usage permission information writing unit that writes the usage permission information in the protected area of the portable medium by releasing the write protection of the portable medium; and
a local terminal that includes
a resource usage permission/prohibition determining unit that determines whether an application is permitted to use the resource based on the user permission information, by reading the user permission information stored, to thereby obtain a determination result; and
a log writing unit that acquires the usage log information based on the determination result, releases the write protection of the portable medium, and writes the usage log information acquired, into the protected area.

13. The resource usage log acquisition system according to claim 12, further comprising:
a resource usage log acquisition permitting unit that permits the application to use the resource, if the usage permission information read includes at least one of limit information that includes period limit information, time limit information, and count limit information for limiting the usage of the resource and permitting the usage of the resource, and if the usage of the resource does not exceed the limit information.

14. The resource usage log acquisition system according to claim 12, wherein if the usage permission information read includes at least any of terminal information that includes an identification number of a hard disk in a usable terminal, an IP address, an identification number of a CPU, and a MAC address, then the resource usage permission/prohibition determining unit makes the determination based on the terminal information.

15. The resource usage log acquisition system according to claim 12, wherein if the usage permission information read includes at least one of authentication information about the portable medium and authentication information about a user, then the resource usage permission/prohibition determining unit makes the determination based on the authentication information.

16. The resource usage log acquisition system according to claim 12, further comprising:
a charging information acquiring unit that acquires charging information corresponding to the usage of the resource by the application, based on the usage log information acquired, releasing the write protection of the portable medium, and writing the charging information acquired, into the protected area.

17. The resource usage log acquiring system according to claim 12, wherein the portable medium is connected to the management server and the local terminal via a USB (Universal Serial Bus).

18. A resource usage log acquisition method comprising:
determining whether an application is permitted to use a resource, by reading usage permission information that is stored in a protected area of a portable medium with write protection enabled, to obtain a determination result, wherein the usage permission information is information about permitting an application to use a resource; and
log acquiring/writing including acquiring usage log information based on the determination result, releasing the write protection of the portable medium, and writing the usage log information acquired into the protected area, wherein the usage log information is information about usage of the resource by the application.

19. A computer-readable recording program including a resource usage log acquisition program that contains instructions which when executed on a computer cause the computer to execute:
determining whether an application is permitted to use a resource, by reading usage permission information that is stored in a protected area of a portable medium with write protection enabled, to obtain a determination result, wherein the usage permission information is information about permitting an application to use a resource; and
log acquiring/writing including acquiring usage log information based on the determination result, releasing the write protection of the portable medium, and writing the usage log information acquired into the protected area, wherein the usage log information is information about usage of the resource by the application.
